(19) United States
(12) Patent Application Publication
(10) Pub. No.: US 2013/0046579 A1
(43) Pub. Date: Feb. 21, 2013

(54) SYSTEM AND METHOD OF ADAPTIVE LOGISTICS PLANNING

(71) Applicant: Frank Feiks, Mannheim (DE)

(72) Inventor: Frank Feiks, Mannheim (DE)

(73) Assignee: SAP AG, Walldorf (DE)

(21) Appl. No.: 13/213,599

(22) Filed: Aug. 19, 2011

(51) Int. Cl. G06Q 10/00

(52) U.S. Cl. 705/7.31

(57) ABSTRACT

A system and method of logistics planning. The method includes storing configuration parameters related to time period planning and reorder point planning in a supply chain. The method further includes receiving demand data corresponding to a demand measurement for an item in the supply chain. The method further includes comparing the demand data and the configuration parameters. The method further includes selecting one of time period planning and reorder point planning for the item as a result of the comparison. In this manner, reordering for items may be adaptively selected between time period planning and reorder point planning in accordance with the actual (measured) demand for the items.

### CROSS REFERENCE TO RELATED APPLICATIONS

Not applicable.

### BACKGROUND

1. Field of the Invention

The present invention relates to supply chain performance, and in particular, to improving supply chain performance by using adaptive planning.

2. Description of the Related Art

Unless otherwise indicated herein, the approaches described in this section are not prior art to the claims in this application and are not admitted to be prior art by inclusion in this section.

Historically, there have been two primary approaches to supply chain network planning. The first approach, time period planning (TPP), uses future demands over a time horizon and distribution planning is optimized for the entire horizon. In this type of planning, the horizon is divided into multiple time periods with distribution occurring within each time period. The second approach to planning, reorder point based planning (ROP), is an approach where distribution planning is driven by a shortfall of available quantities below a minimum level known as the reorder point. Both approaches seek to achieve optimization within their given context. The first approach optimizes for a planning horizon, while the second approach replenishes for current demands without optimization for future demands.

Commonly, TPP is used for sophisticated scenarios and critical parts, while ROP is used for simple scenarios or noncritical parts. ROP has the advantage of relative simplicity and minimal computational effort. In real networks, it may be necessary or desirable to use TPP for one location within the supply chain and ROP for another location within the supply chain for the same product. Unfortunately, since ROP only calculates the demand for a relatively short time frame (e.g., the current period, such as a day) and TPP calculates the demand over a relatively long time frame (e.g., the entire planning horizon), it has not been possible to plan for both TPP and ROP locations in a single planning run.

Performing TPP and ROP in consecutive planning runs leads to the risk that TPP locations are preferred over ROP locations or vice versa. Another risk of sequential planning is that the demands from a child ROP location may be inaccurately considered under a TPP calculation for the parent. U.S. Application Pub. No. 2009/0043638 describes a system to perform TPP and ROP in a single planning run.

### SUMMARY

Given the above background, there is a need for flexible supply chains. When in actual operation the demand for items in the supply chain changes, there is a need to change portions of the supply chain adaptively between TPP and ROP. Furthermore, the system described in U.S. Application Pub. No. 2009/0043638 requires that any node having children that are TPP nodes must itself be a TPP node, and that any node that is a ROP node must only have children that are ROP nodes; there is a need for systems with more flexibility regarding the use of both TPP and ROP within the same supply chain network.

One embodiment is a method of logistics planning. The method includes storing configuration parameters related to time period planning and reorder point planning in a supply chain. The method further includes receiving demand data corresponding to a demand measurement for an item in the supply chain. The method further includes comparing the demand data and the configuration parameters. The method further includes selecting one of time period planning and reorder point planning for the item as a result of the comparison. In this manner, reordering for items may be adaptively selected between time period planning and reorder point planning in accordance with the actual (measured) demand for the items.

The supply chain may include a plurality of nodes and a plurality of items. The nodes may be arranged in a plurality of levels, where the comparing starts with the lowest level. The comparing and the selecting may be performed for each node according to an outer loop performed on a per-item basis, a middle loop performed on a per-level basis, and an inner loop performed on a per-node basis.

The configuration parameters may be stored in a prioritized order. The demand data and the configuration parameters may be compared according to the prioritized order.

A system may perform the method described above. The system includes a storage system, an input/output system, and a processor.

A non-transitory computer readable medium may store instructions to control a computer system to perform the method described above. The instructions may include a storage component, an input/output component, and a processor component.

An embodiment may have one or more of the following features. First, it provides for increased supply chain performance. The supply chain is not forced to use TPP (or ROP) when the other would be more appropriate. Second, it provides for automated supply chain adjustment. Otherwise resources would have to be spent to evaluate and adjust the supply chain manually. Third, it provides advanced analytics to help develop and support more complex supply chains than would otherwise be manageable.

The following detailed description and accompanying drawings provide a better understanding of the nature and advantages of the present invention.

### BRIEF DESCRIPTION OF THE DRAWINGS

FIG. 1 is a flowchart of an adaptive planning process.

FIG. 2 is an example supply chain used to illustrate an example of the operation of the system 2400 (see FIG. 5) and the process 100 (see FIG. 1).

FIG. 3 is a flowchart of a method of adaptive supply chain planning.

FIG. 4 is an example supply chain resulting from performing the process 300 (see FIG. 3) on the supply chain 200 (see FIG. 2) using example configuration parameters and demand data.

FIG. 5 is a block diagram of an example computer system and network 2400 for implementing embodiments of the present invention.

### DETAILED DESCRIPTION

Described herein are techniques for adaptive planning. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

In this document, various methods, processes and procedures are detailed. Although particular steps may be described in a certain sequence, such sequence is mainly for convenience and clarity. A particular step may be repeated more than once, may occur before or after other steps (even if those steps are otherwise described in another sequence), and may occur in parallel with other steps. A second step is required to follow a first step only when the first step must be completed before the second step is begun. Such a situation will be specifically pointed out when not clear from the context. A particular step may be omitted; a particular step is required only when its omission would materially impact another step.

In this document, the terms “and”, “or” and “and/or” are used. Such terms are to be read as having the same meaning; that is, inclusively. For example, “A and B” may mean at least the following: “both A and B”, “only A”, “only B”, “at least both A and B”. As another example, “A or B” may mean at least the following: “only A”, “only B”, “both A and B”, “at least both A and B”. When an exclusive-or is intended, such will be specifically noted (e.g., “either A or B”, “at most one of A and B”).

In this document, various computer-implemented methods, processes and procedures are described. It is to be understood that the various actions (receiving, storing, sending, communicating, displaying, etc.) are performed by a hardware device, even if the action may be authorized, initiated or triggered by a user, or even if the hardware device is controlled by a computer program, software, firmware, etc. Further, it is to be understood that the hardware device is operating on data, even if the data may represent concepts or real-world objects, thus the explicit labeling as “data” as such is omitted. For example, when the hardware device is described as “storing a record”, it is to be understood that the hardware device is storing data that represents the record.

In this document, the term “item” is used. “Items” travel in a supply chain. In general, an item refers the goods moving in the supply chain. An item may be finished, unfinished or of intermediate type, an item may be discrete or non-discrete and an item may consist of other items. Depending on the actual industry context the embodiment of items may be referred to as material, product, part, component, assembly, good, article or others. When travelling through the supply chain, items are consumed, in the sense that the quantity of an item decreases; for example, as components are assembled into a finished product, the quantity of components decreases. Items may also be produced or generated, for example, as finished products. Items may be measured in different ways as appropriate, for example by quantity, by aggregates (e.g., 1000 units in one package), by weight (kilogram, ton, etc.), by volume (barrels, liters, etc.), etc.

“Planning” generally refers to an activity to keep the quantities of items at suitable levels at appropriate points in the supply chain. For example, the terms “order” and “re-order” may be used to describe an activity to increase the quantity of an item when needed. The activities may include, for example, triggering the delivery of items by a member of the supply chain, starting the production of more items, etc.

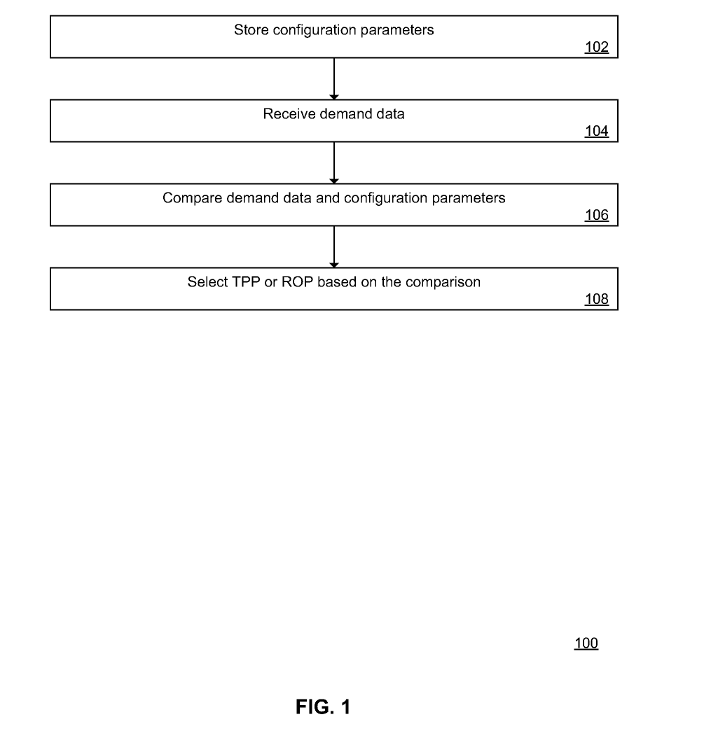

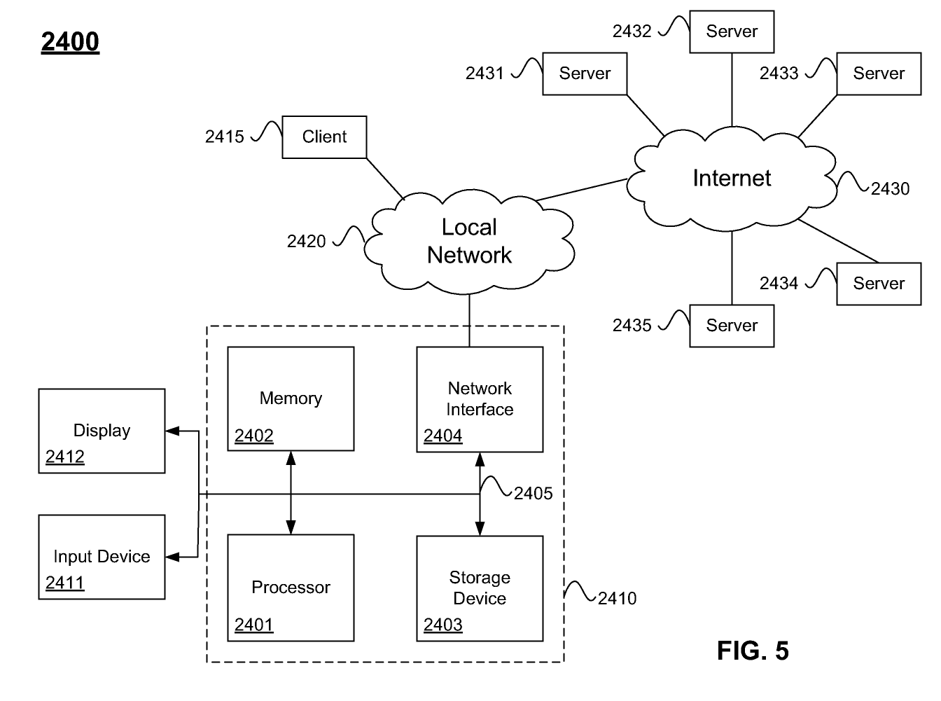

FIG. 1 is a flowchart of an adaptive planning process 100. The adaptive planning process 100 may be performed by the system 2400 (see FIG. 5), e.g. as controlled by one or more computer programs. Such computer programs may be referred to generally as a supply chain management application. The system 2400 may execute other computer programs (also referred to as applications) that interact with the supply chain management application, such as a supplier relationship management application, a customer relationship management application, a product lifecycle management application, an enterprise resource planning application, etc. According to an embodiment, the system 2400 implements a SAP NetWeaver™ technology platform that executes the supply chain management application and other applications.

At 102, configuration parameters are stored. For example, the computer system 2410 may store the configuration parameters, e.g., using the memory 2402 or the storage device 2403.

The configuration parameters relate to TPP and ROP in a supply chain. More specifically, the configuration parameters may be used as thresholds to determine whether TPP or ROP is more appropriate for a given item in the supply chain. (More details regarding this determination are provided with reference to 104 and 106 below.) The configuration parameters may apply to single items or to groups of items. For example, the set of configuration parameters may be provided with validity for the whole supply chain, with validity for each specific group of items (e.g., slow movers, finished goods, A-parts), or with validity for specific item groups and fallback values defined for larger groups or global validity.

The configuration parameters may be adjusted as desired for various supply chain situations. For example, the configuration parameters may be adjusted according to user input (e.g., via the input device 2411) or via information received from another computer (e.g., via the network 2420). More details regarding the configuration parameters are provided below.

At 104, demand data corresponding to a demand measurement for an item in the supply chain is received. For example, the computer system 2410 may receive the demand data from user input (e.g., via the input device 2411) or from information received from another computer (e.g., via the network 2420).

The demand data may correspond to actual (or forecasted) measurements of demand for the item in the supply chain. The demand data may also be binary (e.g., “yes or no”, “true or false”, etc.) regarding whether the item has particular qualities. More details regarding the demand data are provided below.

At 106, the demand data and the plurality of configuration parameters are compared. For example, in the computer system 2410, the processor 2401 may compare demand data stored by the memory 2402 with corresponding configuration parameters stored by the memory 2402.

At 108, either TPP or ROP is selected for the item as a result of the comparison in 106. For example, the computer system 2410 may execute a supply chain management program that manages business objects corresponding to the items in the supply chain; the computer system 2410 may set an attribute of the business object for the item to TPP or ROP as appropriate. According to an embodiment, ROP is the default, and TPP may be selected when the conditions of the comparison (see 106) are met. Further details regarding the comparison, the selection, the configuration parameters, and the demand data are provided below.

Configuration Parameters and Demand Data

Various configuration parameters, and the corresponding demand data measurements, may be used in various embodiments, depending upon the nature and responsiveness of the supply chain modeled by the system 2400. An example embodiment uses seven configuration parameters: a demand data quality parameter, an order quantity parameter, an item quantity parameter, a lead time parameter, a criticality parameter, a demand signal parameter, and a custom parameter. The corresponding demand data for these parameters are a demand data quality measurement, an order quantity measurement, an item quantity measurement, a lead time measurement, a criticality measurement, a demand signal measurement, and a custom measurement.

The first four parameters may be generally referred to as threshold parameters: They are met when the demand data exceeds the corresponding parameter. That is, when in the comparison (see 106) the demand data (measurement) exceeds the corresponding parameter, then TPP is selected, otherwise ROP is selected (see 108).

The demand data quality parameter refers to the significance of the measured demand data versus the forecasted demand data (e.g., according to the mean absolute deviation or standard deviation). To determine the statistical deviation, the standard distribution (or other distributions such as the Poisson distribution) can be applied. For example, an item has a forecasted quantity of 100 pieces with a standard deviation of 17 pieces (17%, respectively). The system's demand data quality parameter is set to the threshold value of 20%. The item is set to TPP because its demand data quality is below the parameter value (that is, the demand data quality is good enough for TPP).

The order quantity parameter refers to the number of orders per time period for the item. For example, the order quantity parameter for an item is set at 10 orders per 30 days; when the order quantity measurement for the item exceed 10 orders within 30 days (e.g., as determined via aggregation of sales/purchase order business objects), then TPP is selected for the item.

The item quantity parameter refers to the quantity of items ordered per time period. For example, the item quantity parameter is set at 100 items within 30 days; when the item quantity measurement for the item exceeds 100 items within 30 days (e.g., as determined via aggregation of item quantities from sales/purchase order business objects), then TPP is selected for the item. When item quantities are aggregated, the unit of measure is taken into account (e.g., weight by kilogram, ton, pound; volume by barrel, liter, fluid ounce; or others).

The lead time parameter refers to the lead time (e.g., production time, procurement time, etc.) required for the item. For example, the system has a lead time threshold parameter of 10 days; when an item has an average lead time of 11 days, then TPP is selected for the item.

The remaining three parameters may be generally referred to as binary parameters: They are met according to whether or not the demand data (measurement) matches the corresponding parameter. That is, when in the comparison (see 106) the demand data (measurement) matches the corresponding parameter, then TPP is selected, otherwise ROP is selected (see 108). (Note that the term “measurement” may still be used to differentiate from the “parameters”, even though the measurement just refers to binary information such as yes/no or the presence/absence of a switch.)

The criticality parameter refers to whether or not the item has been classified as business critical. Setting the criticality measurement for a particular item may be manual or automated. Automated determination may be based on ABC analysis, XYZ analysis, Pareto analysis, etc. as evaluated by an application executed by the system 2400. During the process 100, if a particular item is business critical (e.g., has its criticality data set to true), then TPP is selected. The criticality measurement may be stored as an attribute in a business object representing a particular item.

The demand signal parameter relates to a significant change in item characteristics (e.g., a strong regional sales increase that implies the demand data will increase in the near future). Setting the demand signal measurement may be manual, triggered by an external tool or an automated subsystem. While deriving appropriate demand signals from demand data, market information and human input can be achieved in various ways, the demand signal measurement may be stored as an attribute in a business object representing a particular item in order to be incorporated when setting TPP or ROP.

The custom parameter allows users to set custom planning switches beyond those already evaluated by the system 2400. Examples include when a new item is planned to be introduced, when a marketing campaign is planned to occur, etc. Setting the custom parameter may be manual or automated. Automated determination may be based on integration with other applications executed by the system 2400 (e.g., a marketing campaign is created using a marketing application and the custom data is set to true 30 days before the marketing campaign is scheduled to occur).

Generally, the demand data relates to orders. For example, item quantity data can be determined via aggregation of item quantities from order business objects. Such order business objects can represent sales orders, customer orders, purchase orders, stock transfer orders or other types of item transfer/movement business objects. Demand data can also related to statistical properties of sets of orders, such as ABC classifications.

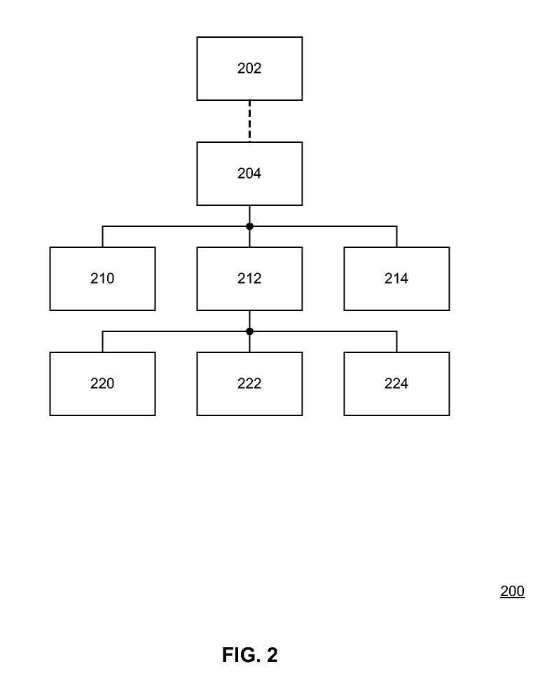

FIG. 2 is an example supply chain 200 used to illustrate an example of the operation of the system 2400 (see FIG. 5) and the process 100 (see FIG. 1). The supply chain 200 includes 8 nodes 202, 204, 210, 212, 214, 220, 222 and 224. The nodes may be classified as parent nodes and child nodes. For example, node 204 is the parent of node 210; node 220 is a child of node 212. Further levels of relationships may be described; for example, node 222 is a child (grandchild) of node 204.

At each node, items come in, items are processed, and items go out. For example, node 204 finishes widgets; it imports unfinished widgets from node 202 and exports finished widgets to nodes 210, 212 and 214. For purposes of the following description, the presence of items is assumed and thus (for brevity) reference may just be made to the nodes. Node 202 is a supplier (to node 204) and may be considered to be outside the adaptive supply chain 200. (The dashed line between node 202 and node 204 illustrates this.)

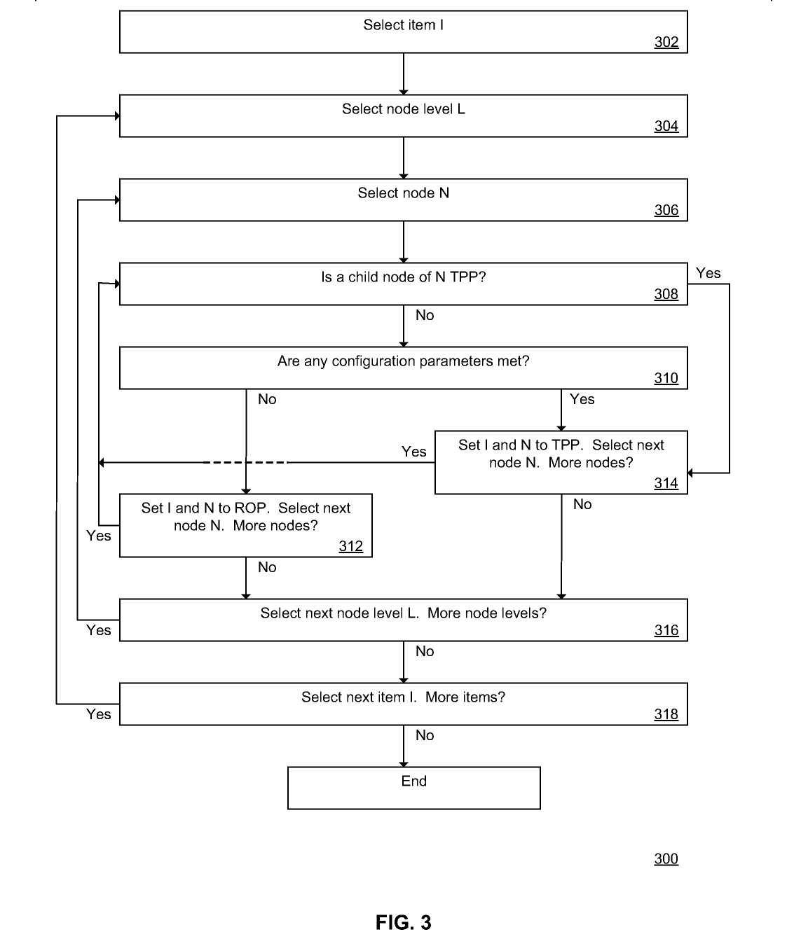

FIG. 3 is a flowchart of a method 300 of adaptive supply chain planning. The method 300 elaborates on 106 from FIG. 1, including the ability to process at the item level as well as the node level. The method 300 (as part of the method 100) may be performed at various times, including when a configuration parameter is changed for a node in the supply chain, when the supply chain management application interacts with another application (e.g., interacting with a sales/purchase order application enables the supply chain management application to obtain the data measurements related to number of sales/purchase orders and ordered item quantity, etc.), or according to a schedule (e.g., the supply chain management application connects nightly to a data warehouse that stores aggregated sales/purchase order information, etc.). The method 300 may be performed by the system 2400 (see FIG. 5), e.g. as controlled by the supply chain management application.

The method 300 may be summarized as follows. Start by cycling through all the items in the supply chain. For a particular item, cycle through its nodes on a level-by-level basis (children first). For each node in a particular level, compare its configuration parameters and its demand data and select TPP or ROP. More details follow.

At 302, select one of the items I in the supply chain.

At 304, for the selected item I, select one of the node levels L starting at the lowest node level (children first).

At 306, for the selected node level L, select one of the nodes N in level L to evaluate.

At 308, for the selected node N, if a child node of N is a TPP node, go to 314; otherwise continue to 310.

At 310, for the selected node N, evaluate whether any of the configuration parameters are met according to the demand data. Within 310, the configuration parameters may be prioritized to be evaluated in a particular order. For example, an example embodiment has seven configuration parameters (demand data quality, order quantity, item quantity, lead time, criticality, demand signal, and custom); one of these may be prioritized to be evaluated first, then another one second, etc. If any of the parameters is met, go to 314; otherwise continue to 312. (Thus, if a higher priority parameter is met, a lower priority parameter need not be evaluated.)

At 312, set I and N to ROP, select the next node N in level L to evaluate, and cycle back to 308; if there are no more nodes in level L, go to 316.

At 314, set I and N to TPP, select the next node N in level L to evaluate, and cycle back to 308; if there are no more nodes in level L, go to 316.

At 316, once there are no mode nodes to evaluate for the selected level L, select the next level L and cycle back to 306; if there are no more node levels for I, go to 318.

At 318, once there are no mode node levels to evaluate for the selected item I, select the next item I and cycle back to 304.

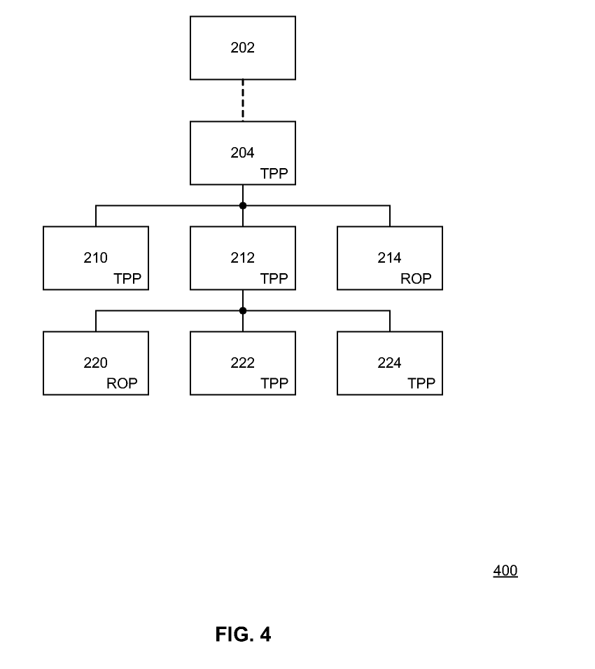

FIG. 4 is an example supply chain 400 resulting from performing the process 300 on the supply chain 200 using example configuration parameters and demand data. TABLE 1 shows the configuration parameters. The “priority” is the order in which the system evaluates the parameters (see 310). The “value” corresponds to the units of the parameter at one or more nodes.

TABLE 1

| Priority | Parameter | Value |
|---|---|---|
| 4 | demand data quality | forecast error <10% |
| 5 | order quantity | orders >1000 per month |
| 6 | item quantity | items >5000 per month |
| 7 | lead time | lead time >70 days |
| 2 | criticality | item X is critical at 212 |
| 3 | demand signal | sales jump of item X at 222 |
| 1 | custom | marketing campaign for item X at 224 |

TABLE 2 shows the demand data. For a particular node, the number of orders, the number of items, and the forecast error are shown.

TABLE 2

| Node | Orders | Items | Forecast Error |
|---|---|---|---|
| 204 | 3000 | 20000 | 2% |
| 210 | 1700 | 4000 | 13% |
| 212 | 900 | 9000 | 11% |
| 214 | 700 | 1200 | 12% |
| 220 | 300 | 2000 | 19% |
| 222 | 900 | 2000 | 21% |
| 224 | 300 | 2000 | 20% |

According to the process 300, start by selecting an item in the supply chain (see 302). (In the supply chain 200, each node corresponds to an item, so 302 will not be relevant.) The lowest node level (see 304) in the supply chain 200 is the level with 220, 222 and 224, so that level is selected. Node 220 is selected to start (see 306). Node 220 has no children (see 308), so continue to evaluating the parameters (see 310) for node 220. Using the demand data in TABLE 2, going through the configuration parameters of TABLE 1 in prioritized order, none are met, so node 220 is set to ROP (see 312) and the node 222 is selected to evaluate next. Node 222 has no children (see 308), so continue to 310. Using the demand data in TABLE 2, going through the configuration parameters of TABLE 1 in prioritized order, the priority 3 parameter “demand signal” is met, so node 222 is set to TPP (see 314), and the node 224 is selected to evaluate next. Node 224 has no children (see 308), so continue to 310. Using the demand data in TABLE 2, going through the configuration parameters of TABLE 1 in prioritized order, the priority 1 parameter “custom” is met, so node 224 is set to TPP (see 314). There are no more nodes in this level to evaluate (see 314) so the node level with nodes 210, 212 and 214 is selected to evaluate next (see 316).

For the selected node level with nodes 210, 212 and 214, select node 210 to evaluate (see 306). Node 210 has no children (see 308), so continue to 310. Using the demand data in TABLE 2, going through the configuration parameters of TABLE 1 in prioritized order, the priority 5 parameter “order quantity” is met, so node 210 is set to TPP (see 314), and the node 212 is selected to evaluate next. Node 212 has child nodes 222 and 224 that are TPP (see 308), so set node 212 to TPP and select node 214 to evaluate next (see 314). Node 214 has no children (see 308), so continue to 310. Using the demand data in TABLE 2, going through the configuration parameters of TABLE 1 in prioritized order, none are met, so node 214 is set to ROP (see 312). There are no more nodes to evaluate in this level (see 312) so the node level with node 204 is selected to evaluate next (see 316).

For the selected node level with node 204, there is only one node to evaluate, so node 204 is selected (see 306). Node 204 has child node 212 that is TPP (see 308), so set node 204 to TPP (see 314). There are no more nodes to evaluate (see 316), no more node levels to evaluate (see 316), and no more items to evaluate (see 318), so the process ends. As a result, nodes 204, 210, 212, 222 and 224 are set to TPP, and nodes 214 and 220 are set to ROP.

FIG. 5 is a block diagram of an example computer system and network 2400 for implementing embodiments of the present invention. Computer system 2410 includes a bus 2405 or other communication mechanism for communicating information, and a processor 2401 coupled with bus 2405 for processing information. Computer system 2410 also includes a memory 2402 coupled to bus 2405 for storing information and instructions to be executed by processor 2401, including information and instructions for performing the techniques described above. This memory may also be used for storing temporary variables or other intermediate information during execution of instructions to be executed by processor 2401. Possible implementations of this memory may be, but are not limited to, random access memory (RAM), read only memory (ROM) (when not storing temporary variables or other intermediate information), or both. A storage device 2403 is also provided for storing information and instructions. Common forms of storage devices include, for example, a hard drive, a magnetic disk, an optical disk, a CD-ROM, a DVD, a flash memory, a USB memory card, a solid state drive, or any other medium from which a computer can read. Storage device 2403 may store source code, binary code, or software files for performing the techniques or embodying the constructs above, for example.

Computer system 2410 may be coupled via bus 2405 to a display 2412, such as a cathode ray tube (CRT) or liquid crystal display (LCD), for displaying information to a computer user. An input device 2411 such as a keyboard and/or mouse is coupled to bus 2405 for communicating information and command selections from the user to processor 2401. The combination of these components allows the user to communicate with the system. In some systems, bus 2405 may be divided into multiple specialized buses.

Computer system 2410 also includes a network interface 2404 coupled with bus 2405. Network interface 2404 may provide two-way data communication between computer system 2410 and the local network 2420. The network interface 2404 may be a digital subscriber line (DSL) or a modem to provide data communication connection over a telephone line, for example. Another example of the network interface is a local area network (LAN) card to provide a data communication connection to a compatible LAN. Wireless links is also another example. In any such implementation, network interface 2404 sends and receives electrical, electromagnetic, or optical signals that carry digital data streams representing various types of information.

Computer system 2410 can send and receive information, including messages or other interface actions, through the network interface 2404 to an Intranet or the Internet 2430. In the Internet example, software components or services may reside on multiple different computer systems 2410 or servers 2431, 2432, 2433, 2434 and 2435 across the network. A server 2431 may transmit actions or messages from one component, through Internet 2430, local network 2420, and network interface 2404 to a component on computer system 2410.

The computer system and network 2400 may be configured in a client server manner. For example, the computer system 2410 may implement a server. The client 2415 may include components similar to those of the computer system 2410.

More specifically, as described above, the computer system 2410 may execute the supply chain management application. The client 2415 may provide a user interface for interacting with the supply chain management application, e.g., to edit the configuration parameters, etc. The server 2431 may implement a data warehouse that stores measurements, that the computer system 2410 interacts with via the network 2430 when performing the process 100 or the process 300.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method of logistics planning, comprising:
storing, by a server computer system, a plurality of configuration parameters related to at least one of a time period planning and a reorder point planning in a supply chain;
receiving, by the server computer system, demand data corresponding to a demand measurement for an item in the supply chain;
comparing, by the server computer system, the demand data and the plurality of configuration parameters; and
selecting, by the server computer system, one of the time period planning and the reorder point planning for the item in the supply chain as a result of comparing the demand data and the plurality of configuration parameters.

2. The computer-implemented method of claim 1, wherein the demand data comprises at least one of a demand data quality measurement, an order quantity measurement, an item quantity measurement, and a lead time measurement.

3. The computer-implemented method of claim 1, wherein the demand data comprises at least one of a criticality measurement, a demand signal measurement, and a custom measurement.

4. The computer-implemented method of claim 1, wherein the supply chain comprises a plurality of nodes and a plurality of items, wherein the one of the time period planning and the reorder point planning is selected for the item and for a corresponding node of the plurality of nodes.

5. The computer-implemented method of claim 1, wherein the supply chain comprises a plurality of nodes and a plurality of items, wherein the item is associated with a corresponding node of the plurality of nodes, and wherein the time period planning is selected for the item and for the corresponding node when a child node of the corresponding node has the time period planning.

6. The computer-implemented method of claim 1, wherein the plurality of configuration parameters are stored in a prioritized order, and wherein the demand data and the plurality of configuration parameters are compared according to the prioritized order.

7. The computer-implemented method of claim 1, wherein the supply chain comprises a plurality of nodes and a plurality of items, wherein the plurality of nodes are arranged in a plurality of levels, wherein the comparing starts with a lowest level of the plurality of levels.

8. The computer-implemented method of claim 1, wherein the supply chain comprises a plurality of nodes and a plurality of items, wherein the plurality of nodes are arranged in a plurality of levels, and wherein the comparing and the selecting are performed for each node in the plurality of nodes according to an outer loop comprising a selected item of the plurality of items, a middle loop comprising a selected level of the plurality of levels, and an inner loop comprising a selected node of the plurality of nodes.

9. A system for logistics planning, comprising:
a storage system that is configured to store a plurality of configuration parameters related to at least one of a time period planning and a reorder point planning in a supply chain;
an input/output system that is configured to receive demand data corresponding to a demand measurement for an item in the supply chain; and
a processor that is configured to compare the demand data and the plurality of configuration parameters, and is configured to select one of the time period planning and the reorder point planning for the item in the supply chain as a result of comparing the demand data and the plurality of configuration parameters.

10. The system of claim 9, wherein the supply chain comprises a plurality of nodes and a plurality of items, wherein the processor is configured to select the one of the time period planning and the reorder point planning for the item and for a corresponding node of the plurality of nodes.

11. The system of claim 9, wherein the supply chain comprises a plurality of nodes and a plurality of items, wherein the item is associated with a corresponding node of the plurality of nodes, and wherein the processor is configured to select the time period planning for the item and for the corresponding node when a child node of the corresponding node has the time period planning.

12. The system of claim 9, wherein the storage system is configured to store the plurality of configuration parameters in a prioritized order, and wherein the processor is configured to compare the demand data and the plurality of configuration parameters according to the prioritized order.

13. The system of claim 9, wherein the supply chain comprises a plurality of nodes and a plurality of items, wherein the plurality of nodes are arranged in a plurality of levels, wherein the processor is configured to start comparing with a lowest level of the plurality of levels.

14. The system of claim 9, wherein the supply chain comprises a plurality of nodes and a plurality of items, wherein the plurality of nodes are arranged in a plurality of levels, and wherein the processor is configured to compare and to select for each node in the plurality of nodes according to an outer loop comprising a selected item of the plurality of items, a middle loop comprising a selected level of the plurality of levels, and an inner loop comprising a selected node of the plurality of nodes.

15. A non-transitory computer readable medium storing instructions to control a computer system for logistics planning, comprising:
a storage component that is configured to control the computer system to store a plurality of configuration parameters related to at least one of a time period planning and a reorder point planning in a supply chain;
an input/output component that is configured to control the computer system to receive demand data corresponding to a demand measurement for an item in the supply chain; and
a processor component that is configured to control the computer system to compare the demand data and the plurality of configuration parameters, and is configured to select one of the time period planning and the reorder point planning for the item in the supply chain as a result of comparing the demand data and the plurality of configuration parameters.

16. The computer readable medium of claim 15, wherein the supply chain comprises a plurality of nodes and a plurality of items, wherein the processor component is configured to select the one of the time period planning and the reorder point planning for the item and for a corresponding node of the plurality of nodes.

17. The computer readable medium of claim 15, wherein the supply chain comprises a plurality of nodes and a plurality of items, wherein the item is associated with a corresponding node of the plurality of nodes, and wherein the processor component is configured to select the time period planning for the item and for the corresponding node when a child node of the corresponding node has the time period planning.

18. The computer readable medium of claim 15, wherein the storage component is configured to store the plurality of configuration parameters in a prioritized order, and wherein the processor component is configured to compare the demand data and the plurality of configuration parameters according to the prioritized order.

19. The computer readable medium of claim 15, wherein the supply chain comprises a plurality of nodes and a plurality of items, wherein the plurality of nodes are arranged in a plurality of levels, wherein the processor component is configured to start comparing with a lowest level of the plurality of levels.

20. The computer readable medium of claim 15, wherein the supply chain comprises a plurality of nodes and a plurality of items, wherein the plurality of nodes are arranged in a plurality of levels, and wherein the processor component is configured to compare and to select for each node in the plurality of nodes according to an outer loop comprising a selected item of the plurality of items, a middle loop comprising a selected level of the plurality of levels, and an inner loop comprising a selected node of the plurality of nodes.
